(19) United States
(12) Patent Application Publication
(10) Pub. No.: US 2008/0059080 A1
(43) Pub. Date: Mar. 6, 2008

(54) Method and system for selective, event-based communications

(75) Inventors: Jonny Ray Greiner, Dunlap, IL (US); Giles Kent Sorrells, Metamora, IL (US); Richard Lee Gordon, East Peoria, IL (US); Anthony James Grichnik, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/513,708

(22) Filed: Aug. 31, 2006

(51) Int. Cl. G06F 19/00; G06F 17/40

(52) U.S. Cl. 702/33; 702/1; 702/182; 702/187; 702/188; 702/183; 702/185; 340/500; 340/540; 340/679

(57) ABSTRACT

A method for selective, event-based communication of machine data includes receiving, in an on-board controller, operation data associated with a component of a machine and comparing the operation data with predetermined threshold data associated with the component. An event alert is generated if the operation data is inconsistent with the predetermined threshold data. The method also includes collecting, in an operational monitoring system associated with the machine, the operation data associated with the component of the machine in response to the event alert. A diagnostic analysis of the operation data associated with the component is performed, the results of which may be to a user of the operational monitoring system.

### TECHNICAL FIELD

The present disclosure relates generally to remote data acquisition and monitoring and, more particularly, to a method and system for selective, event-based communication in machine environments.

### BACKGROUND

Remote monitoring and diagnostic systems are used in a variety of machines, such as automotive vehicles, aircraft, watercraft, construction equipment, transportation systems, hauling equipment, etc. These systems often include sensors and communication equipment for collecting data indicative of machine operations and subsequently transmitting the collected data to an off-board computer system. The off-board system may perform a variety of data analysis tasks associated with a machine environment, such as recording component parameters, performing diagnostic analysis, scheduling preventative maintenance, etc. Each of these tasks may require a considerable amount of raw data from one or more machines operating in the machine environment. As more machines are added to the machine environment, the data flow to the off-board system may be substantial, with each machine providing a considerable amount of information to the off-board system. As a result, costs associated with the project environment may increase, as additional network equipment and infrastructure may be required to support the need for increased bandwidth. In order to limit these costs, a system for controlling the amount of information transferred between the machine and the off-board system may be required.

One method for controlling information that is transmitted between a vehicle and a diagnostic service center is described in U.S. Pat. No. 6,181,994 (“the '994 patent”) to Colson et al. The '994 patent describes a diagnostic system that transmits initial diagnostic information from a vehicle's on-board computer to a diagnostic center computer. In response to the transmission, the system may receive advanced diagnostic routines from the diagnostic center computer, if required by the initial diagnostic information.

Although the system of the '994 patent may limit the amount of information transfer between the vehicle's on-board computer and the diagnostic center computer by transferring only those diagnostic routines required by the vehicle, it may be unreliable. For example, because the advanced diagnostic routines are stored in an off-board system, should any interruption in communication occur between the vehicle and the diagnostic center, the vehicle may not receive the necessary diagnostic routines needed to identify and correct a potential problem. This may lead to serious damage to one or more of the vehicle systems or components and, potentially, premature vehicle failure.

Furthermore, although the on-board computer of the '994 patent may be equipped to perform certain initial diagnostic tests, it may not be adapted to perform preventative (i.e., prognostic) testing. As a result, vehicle data exhibiting potentially problematic performance trends, which may be indicative of eventual component and/or vehicle failure, may not be properly identified and analyzed by the system of the '994 patent. As a result, problems that may be relatively minor when identified and addressed early may go undetected, which may result in component damage and/or vehicle failure.

The presently disclosed method and system for selective, event-based communication are directed toward overcoming one or more of the problems set forth above.

### SUMMARY OF THE INVENTION

In accordance with one aspect, the present disclosure is directed toward a method for selective, event-based communication of machine data. The method may include receiving, in an on-board controller, operation data associated with a component of a machine. The operation data may be compared with predetermined threshold data associated with the component, and an event alert may be generated if the operation data is inconsistent with the predetermined threshold data. The event alert may be provided to an off-board system associated with the machine. The method may also include identifying, based on the event alert, a predetermined response for resolving a cause associated with the event alert.

According to another aspect, the present disclosure is directed toward a method for selective, event-based communication of machine data. The method may include receiving, in an on-board controller, operation data associated with a component of a machine. The operation data may be compared with predetermined threshold data associated with the component, and an event alert may be generated if the operation data is inconsistent with the predetermined threshold data. The method may also include collecting, in an operational monitoring system associated with the machine, the operation data associated with the component of the machine in response to the event alert. A diagnostic analysis of the operation data associated with the component may be performed, the results of which may be provided to a user of the operational monitoring system.

In accordance with another aspect, the present disclosure is directed toward a machine environment having a machine operating in the machine environment, a communication network for communicating data associated with the machine environment, and a system for selective, event-based communication of machine data coupled to the communication network. The system may include one or more sensing devices for collecting operation data associated with a component of the machine. The system may also include an on-board controller communicatively coupled to the one or more sensing devices. The on-board controller may be configured to receive operation data associated with a component of a machine from the one or more sensing devices, and compare the operation data with predetermined threshold data associated with the component. An event alert may be generated if the operation data is inconsistent with the predetermined threshold data. The event alert may be provided to an operational monitoring system associated with the machine, wherein the operational monitoring system is configured to download the operation data in response to the event alert, and perform a diagnostic analysis of the downloaded operation data associated with the component.

### BRIEF DESCRIPTION OF THE DRAWINGS

FIG. 1 illustrates an exemplary disclosed project environment consistent with certain disclosed embodiments;

FIG. 2 provides a schematic illustration of an exemplary on-board controller in accordance with certain disclosed embodiments; and

FIG. 3 illustrates a flowchart depicting an exemplary selective, event-based communication process consistent with certain disclosed embodiments.

### DETAILED DESCRIPTION

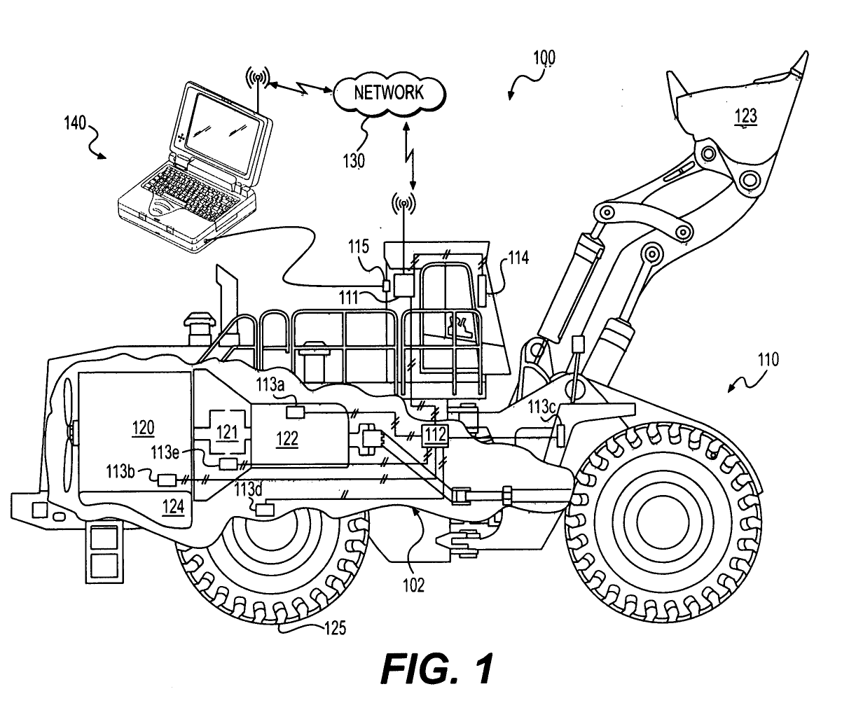

FIG. 1 illustrates a machine environment 100 according to an exemplary disclosed embodiment. Machine environment 100 may include any environment in which one or more machines 110 perform a task associated with an industry such as mining, construction, transportation, energy exploration, farming, or any other type of industry. For example, machine environment 100 may include one or more mine sites in which one or more machines 110 cooperate to perform a task associating with the completion of a mining project.

Machine environment 100 may include a machine 110, operational monitoring system 140, and a communication network 130 for providing data communication between machine 110 and an operational monitoring system 140. Although operational monitoring system 140 is illustrated as a standalone, off-board system with respect to machine 110, it is contemplated that operational monitoring system 140 may include any back-end system that includes computer systems and alert monitoring equipment. It is further contemplated that machine environment 100 may include additional, fewer, and/or different components than those listed above. For example, machine environment 100 may include additional machines and/or machine types.

Machine 110 may include any fixed or mobile machine for performing a task associated with machine environment 100. For example, machine 110 may include a mobile earth moving machine such as a wheel loader, a track-type tractor, a dozer, a motor grader, an excavator, or any other type of machine. Alternatively and/or additionally, machine 110 may include a stationary machine such as a generator set, a pumping device, a turbine, or any other suitable type of stationary machine.

In one embodiment, machine 110 may include one or more components or component systems configured to collect and distribute information associated with machine 110 across machine environment 100. For example, machine 110 may include a system 102 for selective, event based communication of machine data, a display console 114, a communication module 111, and a direct data link 115 configured to communicate with operational monitoring system 140 via communication network 130. It is contemplated that one or more of system 102, direct data link 115, and communication module 111 may be integrated as a single unit. It is further contemplated that machine 110 may include additional, fewer, and or different components than those listed above.

Communication module 111 may include any device configured to facilitate communication between system 102 and operational monitoring system 140. Communication module 111 include hardware and/or software that enables communication module 111 to transmit and/or receive data messages through direct data link 115 and/or via communication network 130. Communication module 111 may include, for example, a network interface (not shown), a wireless transceiver (not shown), and a processor (not shown) configured to collect and distribute data associated with machine 110.

Communication network 130 may include any wired and/or wireless communications suitable for data transmission such as, for example, satellite, cellular, point-to-point, point-to-multipoint, multipoint-to-multipoint, Bluetooth, RF, Ethernet, fiber-optic, coaxial, and/or waveguide communications. Alternatively and/or additionally, communication network 130 may include a direct data link 115, serial, parallel, USB, Ethernet, fiber-optic, fire-wire. Bluetooth, or any other type of transmission medium suitable for direct transfer of information.

System 102 may include one or more components configured to collect information associated with machine 110 during operation of machine 110. For example, system 102 may include one or more sensing devices 113a-e communicatively coupled to a on-board controller 112. System 102 may correspond to an electronic control module (ECM) associated with machine 110 or, alternatively, may embody a standalone unit dedicated to the collection and distribution of machine data. It is contemplated that system 102 may include additional and/or different components than those listed above.

Display console 114 may be communicatively coupled to communication module 111 and may include any audio, video, and/or combination audio-video device suitable for communicating information associated with machine environment 100 to a machine operator. For example, display console may include one or more LCD. CRT, plasma, or any other type of display monitor with a graphical user interface (GUI), one or more indicator lights, and/or an audio device (e.g., speaker, microphone, headset, etc.) that provides operation data associated with a component or subsystem of machine 110 to a machine operator. Alternatively and/or additionally, display console 114 may relay dispatch information (i.e., maintenance and/or repair information, shift change schedules, etc.), operational instructions and/or recommendations, job site data (weather, soil conditions, temperature, etc.), payload information, productivity data, or any other type of information. It is also contemplated that display console 114 may display software applications and/or operator assistance tools (e.g., training tools, etc.) executed by communication module 111 and/or an on-board controller 112.

Sensing devices 113a-e may include any type of sensor or sensor array and may be associated with one or more components of machine 110 such as, for example, a power source 120, a torque converter 121, a transmission 122, a work implement 123, a fluid supply 124, a traction device 125, and/or other components and subsystems of machine 110. Sensing devices 113a-e may be configured to automatically gather operation data associated with one or more components and/or subsystems of machine 110 such as, for example, implement, engine, and/or machine speed and/or location; fluid pressure, flow rate, temperature, contamination level, and or viscosity of a fluid; electric current and/or voltage levels; fluids (i.e., fuel, oil, etc.) consumption rates; loading levels (i.e., payload value, percent of maximum payload limit, payload history, payload distribution, etc.); transmission output ratio, slip, etc.; grade; traction data; scheduled or performed maintenance and/or repair operations; and any other suitable operation data. It is contemplated that sensing devices may be associated with additional, fewer, and/or different components and/or subsystems associated with machine 110 than those listed above.

According to one embodiment, on-board controller 112 may be communicatively coupled to each of sensing devices 113a-e and may include one or more components configured to monitor, record, store, sort, filter, analyze, and/or communicate operation data associated with machine 110 and/or its components and subsystems. These components may include a memory, one or more data storage devices, a central processing unit, a communication interface, or any other components configured to execute an application. For example, on-board controller 112 may correspond to an integrated control module associated with machine 110, such as an electronic control module (ECM) or any other suitable machine control device.

On-board controller 112 may include an electronic control unit of machine 110 and may be communicatively coupled to one or more systems and subsystems of machine 110. As such, on-board controller 112 may be configured to control operations of certain components and subsystems. For example, on-board controller 112 may be communicatively coupled to a fuel injection system associated with a combustion engine of machine 110. On-board controller 112 may be receive an operator command (e.g., increase throttle, etc.) and provide these command signals to the fuel injection system, which may subsequently increase the flow of fuel into the combustion chamber. It is contemplated that, in certain conditions, on-board controller 112 may receive commands directly from operational monitoring system 140 and/or may generate these commands based on certain operation data associated with machine 110.

On-board controller 112 may include one or more software programs configured to analyze operation data collected from sensing devices 113a-e based on predetermined threshold data stored in memory. For example, on-board controller 112 may compare operation data for a particular component or system with predetermined threshold data indicative of normal (i.e., manufacturer specified, design specified, etc.) operation of the particular component or system. Predetermined threshold data, as the term is used herein, refers to any value, limit, range, etc. that establishes an acceptable level of operation associated with a particular component or system. If the operation data is inconsistent with a the predetermined threshold data, on board controller 112 may provide a warning signal (including any associated trouble/error codes) to operational monitoring system 140. The operation data may be determined to be inconsistent with the predetermined threshold data if the operation data is greater than a predetermined threshold value, less than a predetermined threshold value, and/or outside a predetermined threshold range. For instance, data indicative of engine oil pressure may be compared with a predetermined acceptable range. If the oil pressure is outside this range (i.e., lower than a lower range limit or higher than an upper range limit), the oil pressure data is determined to be inconsistent with the predetermined threshold data associated with oil pressure.

According to one embodiment, on-board controller 112 may include one or more software programs for performing diagnostic analysis of machine data. For example, based on the comparison of operation data, one or more trouble codes may be generated. On-board controller 112 may determine, based on the trouble codes, potential causes and/or predetermined courses of action to resolve the trouble code. For example, on-board controller 112 may detect an elevated tire temperature on one or more tires associated with machine 110, which exceeds a predetermined threshold for tire temperature. On-board controller 112 may generate a trouble code associated with the elevated tire temperature. Based on the trouble code, diagnostic software associated with on-board controller 112 may determine that the machine's ground speed is too high, resulting in increased air temperature within the tires. As a result, on-board controller 112 may notify an operator of machine 110 to limit the speed of the machine. Alternatively and/or additionally, on-board controller 112 may transmit a speed limiting signal to one or more of the engine and/or transmission of machine 110 to control the speed of the vehicle until the tire temperature returns to an appropriate level.

According to another embodiment, on-board controller 112 may include one or more software programs for performing prognostic analysis of machine data. For example, on-board controller 112 may analyze current operation data associated with a particular component or subsystem with historical data associated with previous operations of the component. Based on this analysis, performance trends in the operation of the component or system may be identified and compared with failure analysis test data for the particular component, to determine if the performance trend may be indicative of a potential problem. If a potential problem is identified, a prognostic event signal may be provided to operational monitoring system 140, for further investigation.

Operational monitoring system 140 may include one or more computer systems configured to collect, monitor, analyze, evaluate, store, record, and transmit operation data associated with machine 110. Operational monitoring system 140 may be associated with one or more business entities associated with machine 110 such as a manufacturer, an owner, a project manager, a dispatcher, a maintenance facility, a performance evaluator, or any other entity that generates, maintains, sends, and/or receives information associated with machine 110. Although operational monitoring system 140 is illustrated as a laptop computer, it is contemplated that operational monitoring system 140 may include any type of computer system such as, for example, a desktop workstation, a handheld device, a personal data assistant, a mainframe, or any other suitable computer system.

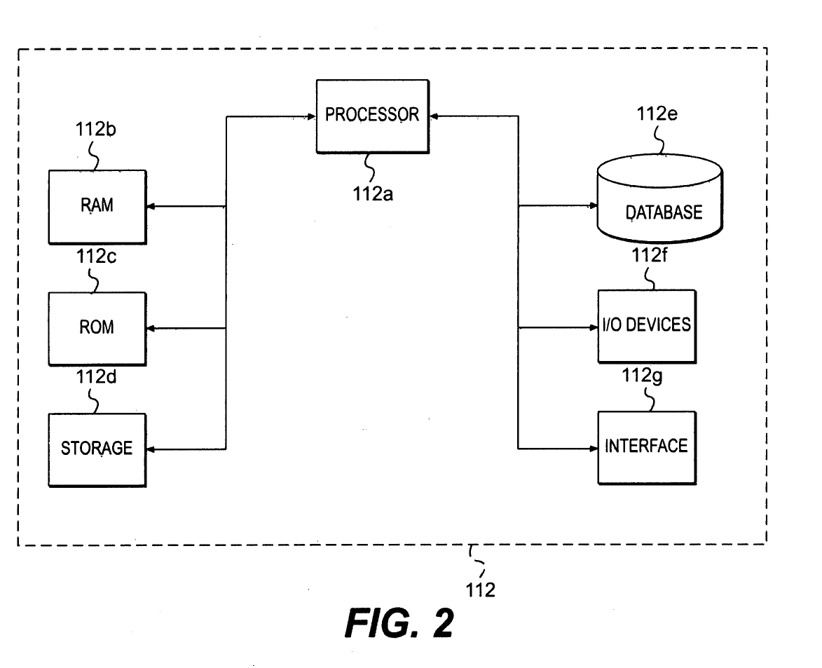

As explained, on-board controller 112 and operational monitoring system 140 may include one or more computer systems and/or other components for executing software programs. For example, as illustrated in FIG. 2, on-board controller 112 may include a processor (i.e., CPU) 112a, a random access memory (RAM) 112b, a read-only memory (ROM) 112c, a storage 112d, a database 112e, one or more input/output (I/O) devices 112f, and an interface 112g. It is contemplated that on-board controller 112 may include additional, fewer, and/or different components than those listed above. It is understood that the type and number of listed devices are exemplary only and not intended to be limiting.

CPU 112a may include one or more processors that can execute instructions and process data to perform one or more functions associated with on-board controller 112. For instance, CPU 112a may execute software that enables on-board controller 112 to request and/or receive operation data from one or more sensing devices 113a-e. CPU 112a may also execute software that enables on-board controller 112 to further analyze one or more diagnostic and/or prognostic alerts to determine a potential preventative maintenance plan. CPU 112a may also execute software that schedules preventative machine maintenance and repair and transmits the schedule to an operator of machine 110 via display console 114. CPU 112a may also execute software that generates, archives, and/or maintains maintenance schedules, prognostic alarms, historical operation data, or any other type of information associated with machine 110.

Storage 112d may include a mass media device operable to store any type of information needed by CPU 112a to perform processes associated with operational monitoring system 140. Storage 112d may include one or more magnetic or optical disk devices, such as hard drives, CD-ROMs, DVD-ROMs, or any other type of mass media device.

Database 112e may include one or more memory devices that store, organize, sort, filter, and/or arrange data used by on-board controller 112 and/or CPU 112a. For example, database 112e may store historical performance data associated with a particular machine 110. Database 112e may also store benchmark and/or other data values associated with machine performance. Database 112e may also store operational parameters for each component or system of components associated with machine 110, including normal operating ranges for the components, threshold levels, etc.

Input/Output (I/O) devices 112f may include one or more components configured to interface with a user associated with machine environment 100. For example, input/output devices may include a console with integrated keyboard and mouse to allow a user of on-board controller 112 (e.g., customer, client, project manager, etc.) to input one or more benchmark values, modify one or more operational specifications, and/or machine operation data. On-board controller 112 may store the performance, productivity, and/or operation data in storage 112d for future analysis and/or modification.

Interface 112g may include one or more elements configured for communicating data between on-board controller 112 and operational monitoring system 140 over communication network 130 and/or direct data link 115. For example, interface 112g may include one or more modulators, demodulators, multiplexers, demultiplexers, network communication devices, wireless devices, antennas, modems, and any other type of device configured to provide data communication between on-board controller 112 and remote systems or components.

Additionally, interface 112g may include hardware and/or software components that allow a user to access information stored in on-board controller 112 and/or operational monitoring system 140. For example, on-board controller 112 may include a data access interface that includes a graphical user interface (GUI) that allows users to access, configure, store, and/or download information to external systems, such as computers, PDAs, diagnostic tools, or any other type of external data device. Moreover, interface 112g may allow a user to access and/or modify information, such as operational parameters, operating ranges, and/or threshold levels associated with one or more component configurations stored in database 112e.

It is contemplated that, while FIG. 2 provides an illustration depicting components associated with an exemplary on-board controller 112, similar components may be included with operational monitoring system 140 for executing certain project and/or data management tasks. For example, operational monitoring system 140 may include one or more components for executing software programs. Accordingly, operational monitoring system 140 may include a processor (i.e.. CPU), a random access memory (RAM), a read-only memory (ROM), a storage, a database, one or more input/output (I/O) devices, and an interface, each with substantially the same functionality and capabilities as those provided in on-board controller 112. It is contemplated that operational monitoring system 140 may include additional, fewer, and/or different components than those listed above. It is understood that the type and number of listed devices are exemplary only and not intended to be limiting.

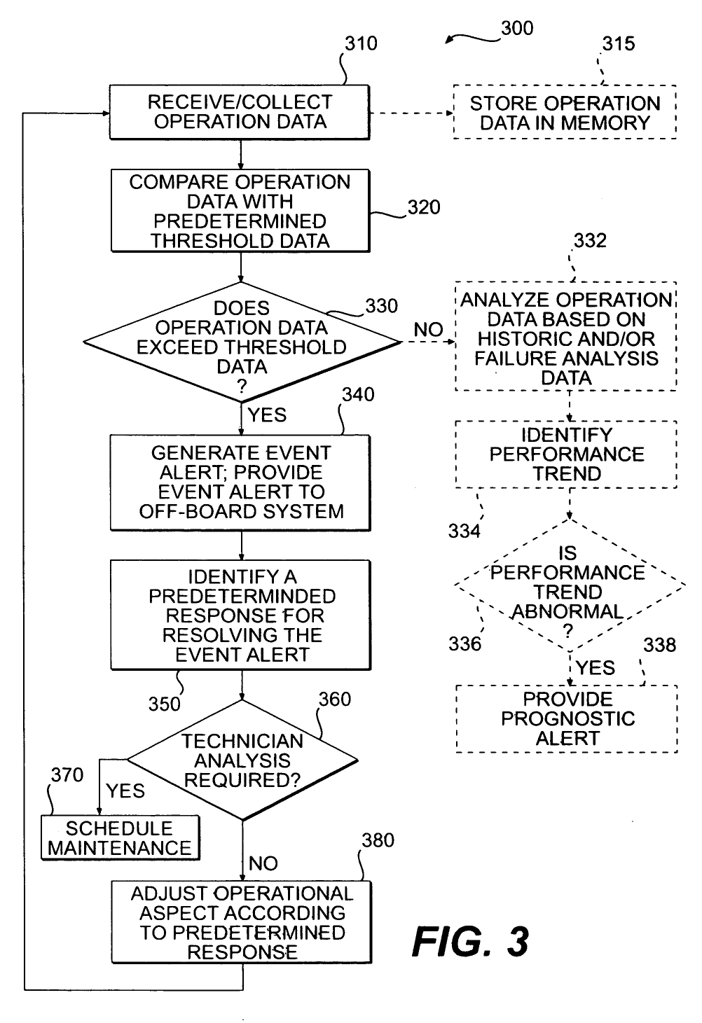

Processes and methods consistent with the disclosed embodiments provide a system for limiting the amount of data transferred between one or more machines and a centralized data monitoring center, by performing a significant amount of the diagnostic and prognostic analysis in an on-board system of each machine. FIG. 3 provides a flowchart 300 depicting an exemplary disclosed method of operation of on-board controller 112. As illustrated in FIG. 3, on-board controller 112 may receive and/or collect operation data associated with machine 112 from one or more sensing devices 113a-e (Step 310). For example, on-board controller 112 may receive operation data from one or more sensing devices 113a-e automatically (e.g., in real-time) during operation of machine 112. Alternatively and/or additionally, on-board controller 112 may collect (e.g., download, etc.) operation data from one or more sensing devices 113a-e, either periodically or continuously.

Once the operation data is received by on-board controller 112, the operation data may (optionally) be stored in the controller's on-board memory (Step 315). The operation data may be time/date stamped and may be organized and/or prioritized based on a variety of criteria, such as, for example, a component ID from the component from which it was received. The stored data may be used in future diagnostic/prognostic analysis tasks associated with on-board controller 112.

According to one embodiment, on-board controller 112 may perform a diagnostic analysis to identify any existing problems associated with machine 112, based on the received operation data. For example, once the operation data has been received and, optionally, stored in memory, operational monitoring system 140 may perform a diagnostic analysis, whereby operation data associated with each component may be compared with the corresponding predetermined threshold data for each component (Step 320). Using the example above, operation data associated with the tire pressure of one or more machine tires may be compared with the predetermined threshold data for tire pressure. The comparison may be analyzed to determine if the operation data is within an acceptable range defined by the predetermined threshold data (Step 330). As previously explained, predetermined threshold data may include manufacturer or user-defined data associated with a particular operating parameter of a component. This threshold data may include specific operational ranges or limits that, when exceeded, may be indicative that the component may be operating in an abnormal manner, potentially resulting in component damage.

If the operation data is inconsistent with the predetermined threshold (i.e., is not within an acceptable range) (Step 330: Yes), and event alert may be provided to operational monitoring system 140, so that preventative measures may be recommended and/or scheduled (Step 340). Event alert, as the term is used herein, refers to any type of signal or message sent by on-board controller 112 to one or more other systems associated with machine 110. These systems may include an operational monitoring system 140, a maintenance and repair scheduling system, a pager associated with a repair technician, an operator console, or any other system configured to receive machine alert notifications. Event alerts may include trouble codes generated by on-board controller 112. identifying certain fault-specific details associated with the problematic data. It is contemplated that these trouble codes may include numerical codes, alphanumeric symbols, or any other type of coded indicia, which, when cross-referenced with a de-coding device (e.g., a lookup table or de-coding database) may provide a detailed description as to the nature and/or cause of the problematic data.

Once the event alert has been generated and provided to the off-board system, a predetermined response for resolving the event alert may be identified (Step 350). A predetermined response may include one or more automated or manual tasks associated with a particular event alarm that may be performed to diagnose, resolve, and/or restore the component to a normal operational state. For instance, predetermined responses may include diagnostic tasks performable by on-board controller 112, a maintenance technician (not shown), and/or operational monitoring system 140 to identify an isolate a cause associated with an operational abnormality corresponding to the event alert. Alternatively and/or additionally, predetermined responses may include operational instructions and/or commands that may be provided to a machine operator for adjusting an operational aspect.

According to one embodiment, on-board controller 112 may be configured to analyze the event alert to determine how to execute the predetermined response. In certain situations, the event alert may require further technical analysis and/or maintenance (Step 360: Yes). Accordingly, machine maintenance may be scheduled by on-board controller 112 and/or operational monitoring system 140 (Step 370). The maintenance schedule maybe provided to the machine operator via display console 114.

Alternatively, on-board controller 112 and/or operational monitoring system 140 may determine that technical analysis and/or maintenance may not be required to resolve the specific event alert (Step 360: No). For example, a particular event alert may be caused by a temporary operational condition associated with the machine. In these situations, one or more of on-board controller 112 and/or operational monitoring system 140 may adjust (Step 380) an operational aspect associated with machine 110 and continuously monitor operation data until the abnormal condition subsides. For instance, following the example above, on-board controller 112 may determine, based on the trouble code analysis, that elevated tire pressure may be caused by excessive heat generated by prolonged elevated ground-speed. As a result, on-board controller 112 may provide instructions to an operator of machine 112, recommending the reduction of vehicle ground until the condition subsides. Alternatively, on-board controller 112 may automatically provide a command signal to an engine and/or transmission controller to limit the speed of machine 112 until the elevated tire temperature subsides.

According to another embodiment, if the operation data does not exceed the threshold data (Step 330: No) indicating that the particular component of machine 110 may be operating appropriately, the operation data may be analyzed based on historic and/or failure analysis data stored in on-board memory (Step 332). For instance, one or more software programs associated with on-board controller 112 may access historical operation data associated with a particular component stored in on-board memory of on-board controller 112. The received operation data for that particular component may be analyzed based on the historical operation data, in order to identify potential problems with the component. Following the example above, software associated with on-board controller 112 may access historical tire temperature data collected by on-board controller 112 for comparison with the received tire temperature data. Alternatively and/or additionally, operation data may be analyzed based on failure test analysis data associated with one or more machine components. For instance, failure test analysis data may include data from a manufacturer or user of machine 120 that includes operation data collected from the component while the component was damaged and/or during failure of the component. Following the example above, failure analysis for a tire associated with machine 120 may include tire temperature data collected during stress testing of a particular component, including operation data collected up to—and during—tire failure.

Based on the analysis of the operation data with respect to historic and/or failure analysis data, on-board controller 112 may identify a performance trend associated with the component (Step 334). In one example, on-board controller 112 may include prognostic software configured to track the operation data for a particular component with historical data from previous operations of the component and identify particular performance trends and/or discrepancies between the compared data. Using the tire temperature example from above, the prognostic software may identify an elevating trend in the received tire temperature data corresponding to increasing tire temperature readings when compared with the historical tire temperature data. This elevating trend may be indicative of a potential problem associated with the tire(s). In another example, received tire temperature data may be compared with the failure analysis data associated with the tire, to determine if the operation data may be indicative of a performance trend corresponding to a failure of the tire. Strong correlation between the tire temperature data and tire failure analysis data may be indicative of a potential failure trend associated with the tire. If the performance trend is determined to be abnormal (Step 336: Yes), on-board controller 112 may transmit a prognostic event alert to operational monitoring system 140 indicating the need for further analysis of the operation data (Step 338).

It is contemplated that, while certain embodiments may be described as being associated with or performed by on-board controller 112, one or more of these embodiments may be performed by operational monitoring system 140 and/or manually. It is also contemplated that on-board controller 112 and operational monitoring system 140 may include tasks management protocols, whereby certain processes may be cooperatively performed by one or both of these systems, in order to maximize speed and efficiency associated with the performance of these processes.

### INDUSTRIAL APPLICABILITY

Methods and systems consistent with the disclosed embodiments enable machine controllers to perform certain diagnostic and/or prognostic functions on-board, thereby limiting the amount of data that is transmitted off-board. Machine environments that employ processes and elements consistent with the disclosed embodiments enable off-board systems to selectively download and analyze operation data associated with individual machines only when the diagnostic and/or prognostic tasks require resources that may be unavailable and/or inaccessible to the on-board systems.

Although the disclosed embodiments are described in association with machine environment 100, the disclosed system and method for selective, event-based communication described herein may be applicable to any environment where it may be desirable to reduce the amount data transferred to a central server by increasing the analytical capabilities of individual systems connected to the server. Specifically, the disclosed selective, event-based communication system may collect and analyze machine operation data in on-board controller associated with the machine to reduce the unnecessary flow of information to off-board systems.

The presently disclosed system and method for selective, event-based communication may have several advantages. First, because a machine's controller is configured to perform most diagnostic and prognostic tasks, risks associated with machine damage due to loss or interruption of communication with a central diagnostic center may be significantly reduced. In addition, costs associated with network equipment and infrastructure required to support the transfer of large amounts of raw operation data may be reduced, as most raw data analysis can be performed in the on-board controller.

Furthermore, the presently disclosed system may be configured to provide prognostic data analysis with historic and/or failure analysis data. By analyzing operation data to identify negative performance trends, potential problems associated with a machine or machine components may be investigated prior to damage to the machine or its constituent components. As a result, project managers may effective schedule preventative maintenance and coordinate replacement equipment in advance of any potential productivity losses associated with unexpected and/or unscheduled repairs.

It will be apparent to those skilled in the art that various modifications and variations can be made to the disclosed system and method for selective, event based communications. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for selective, event-based communication of machine data comprising:
receiving, in an on-board controller, operation data associated with a component of a machine:
comparing the operation data with predetermined threshold data associated with the component;
generating an event alert if the operation data is inconsistent with the predetermined threshold data;
providing the event alert to an off-board system associated with the machine; and
identifying, based on the event alert, a predetermined response for resolving a cause associated with the event alert.

2. The method of claim 1, wherein the off-board system includes an operational monitoring system communicatively coupled to the on-board controller via a wireless communication network, and providing the event alert includes transmitting the event alert to the operational monitoring system via the wireless communication network.

3. The method of claim 2, further including downloading, in the operational monitoring system, the operation data associated with the component of the machine, in response to the event alert.

4. The method of claim 3, further including performing, in the operational monitoring system, a diagnostic analysis of the operation data associated with the component.

5. The method of claim 1, wherein the predetermined response includes:
adjusting one or more operational aspects associated with the machine; and
monitoring the operation data associated with the adjusted operational aspect based on the predetermined threshold data.

6. The method of claim 1, wherein the predetermined response includes providing, to a display console, instructions to an operator of the machine for modifying at least one operation of the machine.

7. The method of claim 1, wherein the predetermined response includes scheduling maintenance for the machine.

8. The method of claim 1, further including:
analyzing, if the operation data does not exceed predetermined threshold data, the operation data based on one or more of historic operation data and failure analysis data associated with the component;
identifying a performance trend associated with the component, based on the analysis; and
providing a prognostic alert indicative if the performance trend is indicative of abnormal performance of the component.

9. A method for selective, event-based communication of machine data comprising:
receiving, in an on-board controller, operation data associated with a component of a machine:
comparing the operation data with predetermined threshold data associated with the component;
generating an event alert if the operation data is inconsistent with the predetermined threshold data;
collecting, in an operational monitoring system associated with the machine, the operation data associated with the component of the machine in response to the event alert;
performing a diagnostic analysis of the operation data associated with the component; and
providing results from the diagnostic analysis to a user of the operational monitoring system.

10. The method of claim 9, wherein generating an event alert includes transmitting the event alert to the operational monitoring system via the wireless communication network.

11. The method of claim 9, further including identifying, based on the event alert, a predetermined response for resolving a cause associated with the event alert.

12. The method of claim 11, wherein the predetermined response includes:
adjusting one or more operational aspects associated with the machine; and
monitoring the operation data associated with the adjusted operational aspect based on the predetermined threshold data.

13. The method of claim 11, wherein the predetermined response includes providing, to a display console, instructions to an operator of the machine for modifying at least one operation of the machine.

14. The method of claim 11, wherein the predetermined response includes scheduling maintenance for the machine.

15. The method of claim 9, further including:
analyzing, if the operation data does not exceed predetermined threshold data, the operation data based on one or more of historic operation data and failure analysis data associated with the component;
identifying a performance trend associated with the component, based on the analysis; and
providing a prognostic alert indicative of a potential future problem if the performance trend is indicative of abnormal performance of the component.

16. A machine environment comprising:
a machine operating in the machine environment;
a communication network for communicating data associated with the machine environment;
a system for selective, event based communication of machine data coupled to the communication network, the system including:
one or more sensing devices for collecting operation data associated with a component of the machine;
an on-board controller communicatively coupled to the one or more sensing devices and configured to:
receive operation data associated with the component of the machine from the one or more sensing devices:
compare the operation data with predetermined threshold data associated with the component;
generate an event alert if the operation data is inconsistent with the predetermined threshold data; and
provide the event alert to an operational monitoring system associated with the machine, wherein the operational monitoring system is configured to:
download the operation data, in response to the event alert; and
perform a diagnostic analysis of the downloaded operation data associated with the component.

17. The environment of claim 16, wherein the on-board controller is further configured to identify, based on the event alert, a predetermined response for resolving a cause associated with the event alert.

18. The environment of claim 17, wherein the predetermined response includes:
adjusting one or more operational aspects associated with the machine; and
monitoring the operation data associated with the adjusted operational aspect based on the predetermined threshold data.

19. The environment of claim 17, wherein the predetermined response includes providing, to a display console, instructions to an operator of the machine for modifying at least one operation of the machine.

20. The environment of claim 16, further including:
analyzing, if the operation data does not exceed predetermined threshold data, the operation data based on one or more of historic operation data and failure analysis data associated with the component;
identifying a performance trend associated with the component, based on the analysis; and
providing a prognostic alert indicative of a potential future problem if the performance trend is indicative of abnormal performance of the component.
